(19) United States
(12) Patent Application Publication
(10) Pub. No.: US 2011/0110708 A1
(43) Pub. Date: May 12, 2011

(54) INTERCHANGEABLE HOIST AND DRAG LINK

(75) Inventors: Bernard Anthony Miotke, Sublimity, OR (US); Andrew Joseph Fuchs, Vancouver, WA (US)

(73) Assignee: Columbia Steel Casting Co., Inc.

(21) Appl. No.: 12/616,038

(22) Filed: Nov. 10, 2009

(51) Int. Cl. F16C 11/00; E02F 3/58; B23P 11/00

(52) U.S. Cl. 403/64; 37/399; 29/428

(57) ABSTRACT

Embodiments of a dragline rigging can reduce the number of different parts required by including an interchangeable dragline rigging link that can be used, in different orientations, as either a hoist link or a drag link. An interchangeable dragline rigging link can include a socket connector, a dump connector, and chain connectors on either side of the link. The socket connector and dump connector can include parallel pin receiving holes, while the chain connectors can accommodate pins in a direction perpendicular to the pin receiving holes of the socket connector and dump connector. Further, the hoist assembly and drag assembly of the dragline rigging can be designed to accommodate the same size pin at a plurality of locations, in order to further increase the interchangeability of parts of the dragline rigging.

### FIELD

The disclosure relates to a dragline rigging assembly, and specifically to an interchangeable hoist and drag link that can be used in a dragline rigging assembly.

### BACKGROUND

Dragline excavation systems are heavy equipment used in civil engineering and industrial applications such as surface mining. In civil engineering, smaller dragline systems are used for road and port construction. Larger dragline systems are used in strip-mining operations to, for example, move overburden above coal, and for tar-sand mining. Large draglines are used in the mining of coal, lignite, phosphate, and other materials.

A schematic of a large dragline bucket system is shown in FIG. 1. As seen in FIG. 1, a dragline bucket system 100 typically consists of a large bucket 102 that is suspended from a boom (a large truss-like structure) 104 with wire ropes 106, 108. The bucket 102 is maneuvered by the ropes 106, 108 and chains 110, 112. The hoist rope 106, powered by a large diesel or electric motor 114, supports the bucket 102 and hoist-coupler assembly 116 from the boom 104. The drag rope 108 is used to draw the bucket assembly 102 horizontally across the ground or other surface. The bucket 102 is controlled for various operations by maneuver of the hoist and the drag ropes 106, 108.

In a typical cycle of excavation, the dragline is positioned above the material to be excavated. The bucket 102 is then lowered and the drag rope 108 is then drawn so that the bucket 102 is dragged along the surface of the material, thereby scooping up the material. The bucket 102 is then lifted using the hoist rope 106. A swing operation is then performed to move the bucket 102 to a place where the material is to be dumped. The drag rope 108 is then released, causing the bucket 102 to tilt and empty, thus dumping the material.

Typically, a hoist assembly, a drag assembly, and a dump assembly are interconnected by links and pins. The pins and their bearing surfaces are subject to wear over time, and require regular servicing and/or replacement. Dragline excavators are typically operated continuously, with only minimal amounts of down time for periodic maintenance. Consequently, the rigging, pins, and other parts must be designed for function and excessive wear conditions. Operators must have a number of parts on hand for repair and replacement of damaged and failing parts. A need remains for dragline excavation systems requiring fewer parts to be kept on hand for repair and replacement.

### SUMMARY

Embodiments of a dragline rigging according to the present disclosure can reduce the number of different parts required by including an interchangeable dragline rigging link that can be used, in different orientations, as either a hoist link or a drag link. Further, the hoist assembly and drag assembly of the dragline rigging can be designed to accommodate the same size pin at a plurality of locations, in order to further increase the interchangeability of parts of the dragline rigging.

According to one embodiment, a dragline rigging link can be positioned interchangeably as a drag link or a hoist link in a dragline bucket rigging. The link can comprise a socket lug, or connector, adjacent an upper end of the dragline rigging link and having a first pin receiving hole extending there through in a first longitudinal direction, a dump lug, or connector, adjacent a lower end of the dragline rigging link and having a second pin receiving hole extending there through in the first longitudinal direction, and first and second chain connectors positioned along opposing sides of the dragline rigging link, each of the first and second chain connectors being configured to receive a pin in a second longitudinal direction, wherein the second longitudinal direction is substantially perpendicular to the first longitudinal direction.

In some embodiments, the first and second chain connectors are configured to allow movement of chains in a direction perpendicular to the longitudinal direction, when said chains are coupled to the first and second chain connectors. The first and second chain connectors can be configured to allow rotation of chains about an axis in the longitudinal direction, when said chains are coupled to the first and second chain connectors.

A socket can be coupled to the socket connector, and the socket and socket connector can be configured to allow movement of chains in the longitudinal direction, when said chains are coupled to the first and second chain connectors.

In some embodiments, each of the first and second chain connectors has a pin protector extension that protects pins mounted in the chain connectors when the link is dragged. Each of the first and second chain connectors can comprise a first and second chain connector tab spaced apart from one another for receiving a chain link between the tabs. In such embodiments, the second chain connector tabs comprises a recess configured to accommodate a pin head. At least a portion of each of the second chain connector tabs can be hard faced.

Some embodiments of an interchangeable dragline rigging link include a dump connector and/or a socket connector that comprises a single tab. Some disclosed embodiments of a dragline rigging link include a dump connector and/or a socket connector that comprises two tabs. The dragline rigging link can be monolithic.

Disclosed embodiments of dragline rigging can also provide for interchangeable pins used in a plurality of locations. For example, the first and second chain connectors can be configured to receive pins of the same size that the pin receiving holes of the dump connector and socket connector are configured to receive. Similarly, embodiments of a dragline rigging can provide for interchangeable sockets. For example, the socket connector can be sized to receive a socket of the same size in both the hoist link position and the drag link position.

The present disclosure also concerns a dragline rigging assembly that comprises a hoist link assembly and a drag link assembly. The hoist link assembly can comprise a hoist socket coupled to a socket connector of a first dragline rigging link, a dump block coupled to a dump connector of the first dragline rigging link, and first and second hoist chains coupled to first and second chain connectors of the first dragline rigging link, said first and second hoist chains being coupled to opposing sides of a bucket. The drag link assembly can comprise a drag socket coupled to a socket connector of a second dragline rigging link, a dump rope coupled to a dump connector of the second dragline rigging link, and first and second drag chains coupled to first and second chain connectors of the second dragline rigging link, said first and second drag chains being coupled to the bucket, adjacent a bucket opening. The first and second dragline rigging links are interchangeable.

In some embodiments, the hoist link assembly is configured to allow both forward and back motion and side to side motion of the first and second hoist chains. The drag link assembly can be configured to allow both up and down motion and side to side motion of the first and second drag chains.

In some embodiment of a dragline rigging assembly, the socket connector and the dump connector of the first and second dragline rigging links each includes a pin receiving hole configured to receive a pin oriented in a first direction, and the first and second chain connectors of the first and second dragline rigging links are each configured to receive a pin oriented in a second direction substantially perpendicular to the first direction. Each pin receiving hole can be configured to receive the same size pin as each of the first and second chain connectors.

Methods of assembling a dragline rigging assembly are also disclosed. One such method comprises providing first and second dragline rigging links, wherein the first and second dragline rigging links are interchangeable, coupling the first dragline rigging link to a hoist socket, one or more hoist chain assemblies, and a dump block via a plurality of pins, coupling the second dragline rigging link to a drag socket, one or more drag chain assemblies, and a dump rope via a plurality of pins, coupling the one or more hoist chain assemblies to opposing sides of a bucket, and coupling the one or more drag chain assemblies to the bucket, adjacent a bucket opening.

In some methods, each of the plurality of pins is the same size. In some embodiments, the hoist chain assemblies each comprises an upper hoist chain and a lower hoist chain, wherein the upper and lower hoist chains are coupled via a spreader bar assembly, the upper hoist chains being coupled to the first dragline rigging link, and the lower hoist chains being connected to the bucket via a trunnion.

The foregoing and other objects, features, and advantages of the invention will become more apparent from the following detailed description, which proceeds with reference to the accompanying figures.

### BRIEF DESCRIPTION OF THE DRAWINGS

FIG. 1 illustrates a schematic of a dragline excavation system according to the prior art.

FIG. 2 is a perspective view of a dragline bucket and rigging.

FIG. 3 is an exploded view of the components of a hoist link assembly of a dragline rigging.

FIG. 4 is an exploded view of the components of a drag link assembly of a dragline rigging.

FIG. 5 shows a perspective view of an interchangeable dragline rigging link.

FIG. 6 shows a perspective view of the interchangeable dragline rigging link of FIG. 5 in an alternate orientation.

FIG. 7 is an elevation view of an interchangeable dragline rigging link.

FIG. 8 is a section view of an interchangeable dragline rigging link taken along line 8-8 of FIG. 7.

FIG. 9 is a block diagram illustrating one method of assembling a dragline rigging.

### DETAILED DESCRIPTION

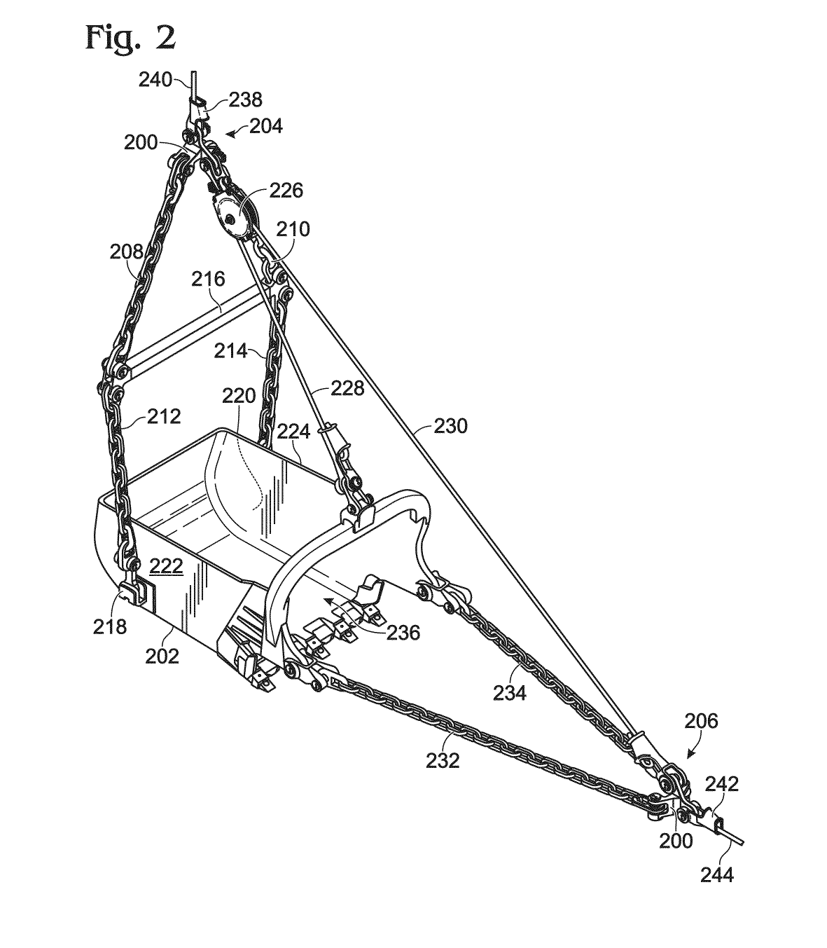

One embodiment of the present disclosure concerns an interchangeable dragline rigging link 200 that can be used with the dragline bucket 202 shown in perspective view in FIG. 2. The same interchangeable dragline rigging link 200 (or clevis), hereinafter referred to as interchangeable link 200, can be included in both a hoist assembly 204 and a drag assembly 206. When used in these different positions in the dragline rigging, the interchangeable link 200 can be positioned in different orientations, as will be described further below. Designing a dragline rigging that allows for the same piece of hardware to be used in multiple locations on the rigging can reduce the inventory of parts required, and thus simplify repairs and maintenance of the dragline rigging.

As seen in FIG. 2, the bucket 202 is supported from above by the hoist assembly 204 via upper hoist chains 208, 210 and lower hoist chains 212, 214. Upper hoist chains 208 and 210 can be coupled to lower hoist chains 212 and 214, respectively, via a spreader bar 216. Lower hoist chains 212 and 214 are coupled to opposing sides 222, 224, respectively, of the bucket 202 via trunnions 218, 220, respectively. The hoist assembly 204 also includes a dump block 226 that is coupled to the top of bucket 202 via a dump rope 228, and coupled to the drag assembly 206 via a dump rope 230.

The spreader bar 216 shown in FIG. 2 can be provided with different end options. The spreader bar 216 can be optimized for certain dragline rigging assemblies, such as those with 15 and 30 yard buckets. While FIG. 2 shows a square pipe spreader bar 216, alternative embodiments include a circular pipe spreader bar, such as an 8 inch diameter pipe. Depending on the type of spreader bar used, different spreader bar ends can be included in the assembly, as appropriate.

The drag assembly 206 is further coupled to the bucket 202 with drag chains 232, 234 that are coupled to opposing sides of the bucket 202 adjacent a bucket opening 236.

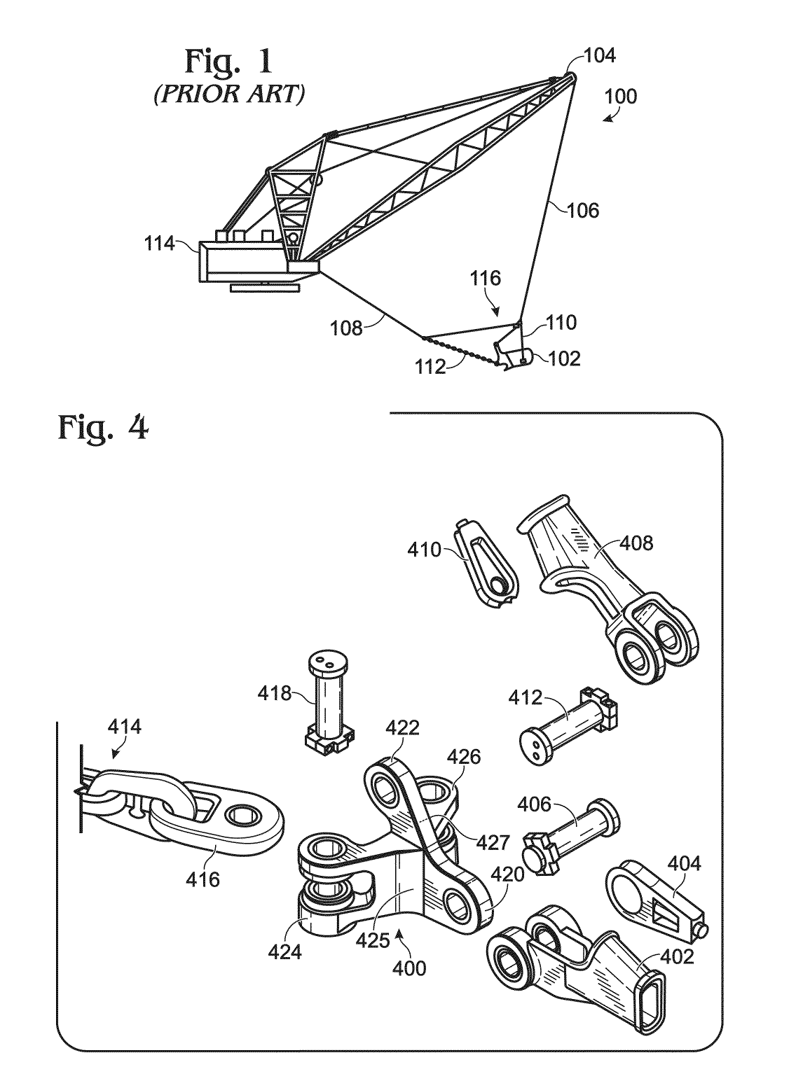

The bucket 202 can be controlled using a dragline rigging, as shown generally in FIG. 1. The bucket assembly shown in FIG. 2 can be controlled using a hoist rope 240 coupled to the hoist assembly 204 via a socket 238 and using a drag rope 244 coupled to the drag assembly 206 via a socket 242, as is well known in the art. In some embodiments, the sockets 238 and 242 can be the same size. Thus, the interchangeable link 200 can be configured to accommodate the same size socket whether positioned as a hoist link in the hoist assembly 204 or as a drag link in the drag assembly 206.

The interchangeable link 200 at the drag assembly 206 can allow for both up and down movement of the bucket 202 and chains 232, 234 at the socket 242, as well as side to side movement of the bucket 202 and chains 232, 234, via the coupling of the chains 232, 234 to the link 200. The interchangeable link 200 at the hoist assembly 204 can allow for both forward and back movement of the bucket 202 and chains 208, 210 at the socket 238, as well as side to side movement of the bucket 202 and chains 208, 210, via the coupling of the chains 208, 210 to the link 200.

The forward and back motion that occurs at the coupling of the socket 238, rather than were the chains connect to the link 200, is considered less than ideal by some skilled in the art. Conventional hoist links are configured to optimize forward and back swinging at the hoist link, with side-to-side motion occurring at the socket. However, in order to achieve interchangeability of the hoist link and drag link as presently described, such less than ideal motion is tolerated in the hoist assembly 204 in order to optimize the side to side motion when used as a drag link in the drag assembly 206. The presently disclosed interchangeable link can allow for two degrees of freedom (e.g., front to back motion and side to side motion) at both the hoist assembly 204 and the drag assembly 206. In some embodiments, to alleviate wear on the chains 208, 210 or links in the hoist assembly 204 due to motion of the bucket 202, a swivel link can be used to couple the chains 208, 210 to the interchangeable link 200.

The interchangeable link 200 can thus be designed to accommodate both front to back and side to side motion when positioned in either or both the hoist assembly 204 and the drag assembly 206.

While one type of rope sockets are shown in FIG. 2, alternative embodiments can include one or more ferrule sockets or other socket types, as will be appreciated by one skilled in the art.

FIG. 3 is an exploded view of the components of one embodiment of a hoist link assembly useful as part of a dragline rigging. Central to the hoist assembly is the interchangeable link 300, which can also be included as part of a drag assembly, as will be shown in FIG. 4. The interchangeable link 300 can be coupled to a hoist rope (shown in FIG. 2), such as by a socket 302 and wedge 304, which can be secured to the interchangeable link 300 via a pin 306 near a socket lug, projection, or connector 308 adjacent a top end 309 of the interchangeable link 300. Rotation about pin 306 can allow forward to back motion of the bucket of a dragline rigging. The socket 302 and wedge 304 can each include a window for hydraulic ram wedge removal in some embodiments.

The interchangeable link 300 can also be coupled to a dump rope (shown in FIG. 2), such as by a dump block 310 and swivel link 312. The swivel link 312 can be coupled to the interchangeable link 300 at a dump lug, projection, or connector 314 of the link, adjacent a lower end 315 of the link, via a pin 316, and coupled to the dump block 310 via a pin 318. The swivel link 312 can facilitate up and down motion of the bucket 202 and chains by rotation around pin 316, and can facilitate side to side motion of the bucket 202 and chains by rotation around pin 318.

Chain connectors 326, 328 on opposing sides 327, 329 of the interchangeable link 300 can each be coupled to an upper hoist chain 320, such as by an end link 322 and pin 324. In some embodiments, the end link 322 can be hard faced, such as by a manganese overlay on at least a portion of the surface in contact with the mating chain link. In some embodiments, a swivel link can be used in place of or in addition to end link 322. While the ends links 322 shown in FIG. 3 are illustrated as being oriented in the same plane, end links on opposite ends of the chain 320 can be rotated ninety degrees from one another in some embodiments. Rotation of the hoist chains 320 about pin 324 can allow for side to side motion of the bucket and chains of a dragline rigging.

In some embodiments, one or more of pins 306, 316, 318, and 324 can be the same size, and thus can be interchangeable as well. This can further reduce the inventory of parts required for repair and maintenance of the dragline rigging.

FIG. 4 is an exploded view of the components of one embodiment of a drag link assembly useful as part of a dragline rigging. A drag link assembly can include an interchangeable link 400 that is the same as the interchangeable link 300 shown in the hoist link assembly of FIG. 3. Interchangeable link 400 can be coupled to a drag assembly (e.g., the drag rope shown in FIG. 2) via a drag socket 402 and wedge 404, which are secured to the interchangeable link 400 at a socket connector 420 using a pin 406. The connection of the drag socket 402 to the interchangeable link 400 can allow for rotation about pin 406, and thus up and down movement of the bucket and chains of the dragline rigging. The socket 402 and wedge 404 can each include a window for hydraulic ram wedge removal in some embodiments.

Interchangeable link 400 can also be coupled to a dump assembly (shown in FIG. 2) via a dump socket 408 and wedge 410, which are secured to the interchangeable link 400 at a dump connector 422 using a pin 412. Chain connectors 424, 426 on opposing sides 425, 427 of the interchangeable link 400 can each be coupled to a drag chain 414, such as by an end link 416 and pin 418. Rotation of the drag chains 414 about pin 418 can allow for side to side motion of the bucket and chains of a dragline rigging. Disclosed drag link assemblies including the interchangeable link 400 can be designed to allow for the use of buckets of varying sizes and widths.

Some embodiments can include a drag chain that is hard faced, such as by a manganese overlay, on at least a portion of the chain. For example, the end links can include a manganese overlay on the surface that contacts the adjacent link of the drag chain (the bite area). Further, the end links can include hard facing on the side rails. Some or all of the chain links of the drag chain can be hard faced along the side rails. In one embodiment, the last four links (in addition to the end links) on each end of the drag chain are hard faced along their side rails.

In some embodiments, one or more of pins 406, 412, and 418 can be the same size, and thus can be interchangeable as well. This can further reduce the inventory of parts required for repair and maintenance of the dragline rigging.

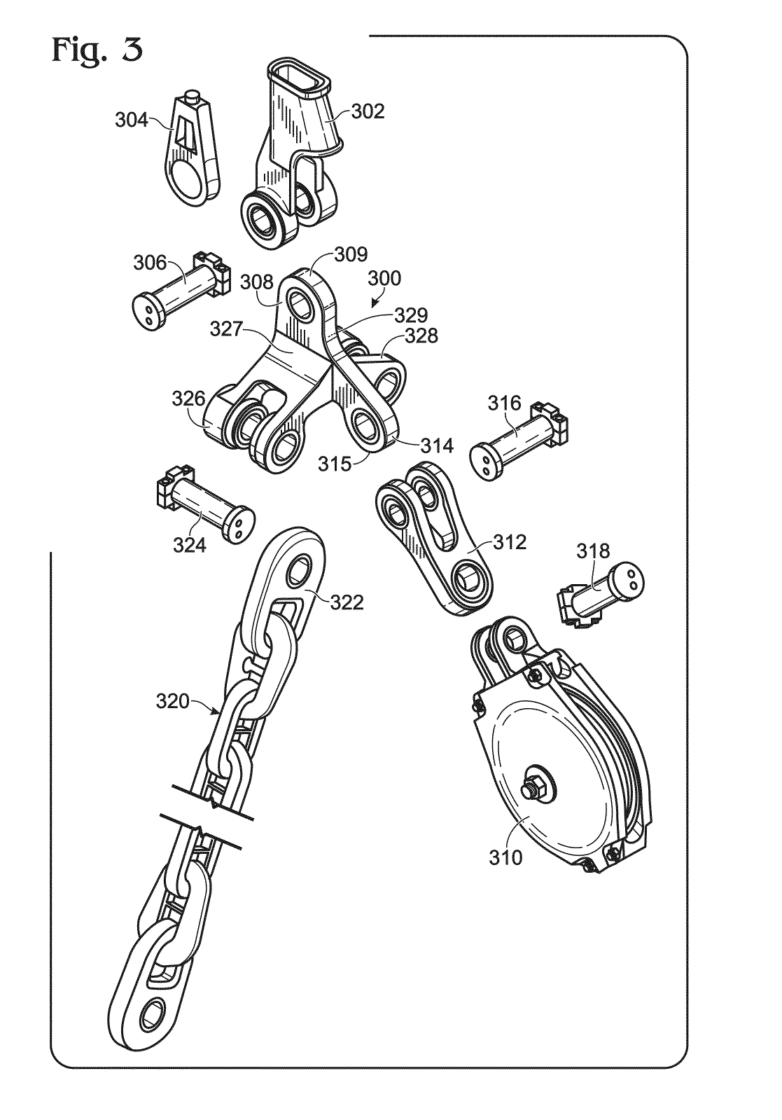

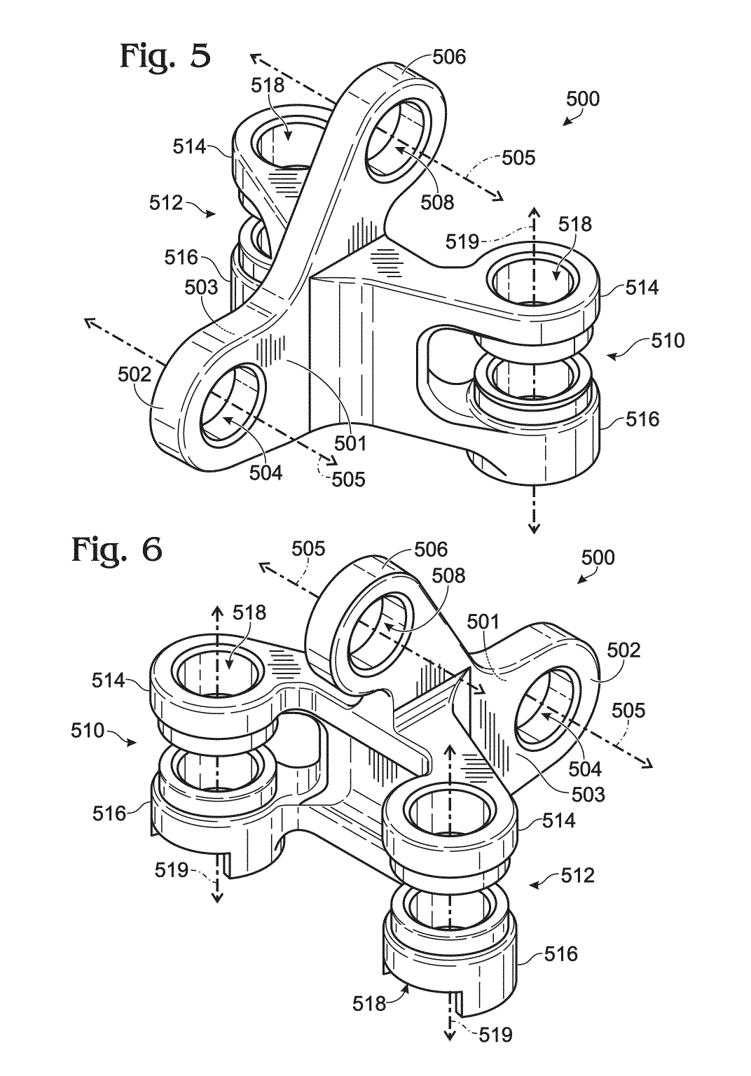

FIGS. 5-6 show perspective views of an interchangeable dragline rigging link in different orientations. In one embodiment, the interchangeable link can be oriented one way when used in a hoist assembly (e.g., as a hoist link) of a dragline rigging, and the interchangeable link can be oriented differently when used in a drag assembly (e.g., as a drag link). As shown in FIGS. 5-6, the interchangeable link 500 can include a socket connector 502 having a pin receiving hole 504 extending there through, in a longitudinal direction indicated by arrow 505, extending from one side 501 of the link 500 to the opposite side 503. The socket connector 502 can thus be configured to be coupled to a socket. The socket connector 502 can comprise a single tab extending from the main body of the link 500. In alternate embodiments, the socket connector 502 can comprise a double tab extending from the main body of the link 500.

The interchangeable link 500 can also include a dump connector 506 having a pin receiving hole 508 extending there through. The dump connector can thus be configured to be coupled to a socket and/or dump block. The dump connector 506 can comprise a single tab extending from the main body of the link 500. In alternate embodiments, the dump connector 506 can comprise a double tab extending from the main body of the link 500. Pin receiving holes 504 and 508 can be at least substantially parallel to one another. Further, pin receiving holes 504, 508 can be configured to receive the same size pins.

Interchangeable link 500 can also include chain connectors 510, 512 on opposing sides 501, 503 of the link 500. Each chain connector 510, 512 can comprise a first tab 514 and a second tab 516, the first and second tabs 514, 516 being spaced apart from one another. Each chain connector 510, 512 can include a pin receiving hole 518 configured to receive a pin for coupling to a chain. For example, in the embodiment shown in FIGS. 5-6, the pin receiving holes 518 extend through both the first and second tabs 514, 516 of each of the chain connectors 510, 512. Pin receiving holes 518 can be configured to receive the same size pins as the pin receiving holes 504 and/or 508.

Pin receiving holes 518 extend through the chain connectors 510, 512 in a second longitudinal direction indicated by arrow 519, the second longitudinal direction 519 being substantially perpendicular to the first longitudinal direction 505. Thus, pins inserted into the pin receiving holes 504 and 508 are substantially perpendicular to the pins inserted into the pin receiving holes 518.

The socket connector 502, as shown, is configured to facilitate movement of chains in the second longitudinal direction 519 when chains are coupled to the chain connectors 510, 512. The chain connectors 510, 512 can be configured to allow movement of chains in the first longitudinal direction 505 (e.g., a direction substantially perpendicular to the second longitudinal direction 519). For example, when chains are coupled to chain connectors 510, 512, the chains can rotate about the pins inserted into pin receiving holes 518, and thus can rotate about an axis in the second longitudinal direction 519.

Chain connectors 510, 512 can be configured to protect at least a portion of the pins inserted into the pin receiving holes 518. For example, the chain connectors can provide protection for the pin heads of the pins inserted into the pin receiving holes 518. Such protection can help to reduce wear on the pins when the interchangeable link 500 is used in the drag link position, and the link 500 is dragged along the ground during use. As shown in FIGS. 5-6, the second tabs 516 can be longer in the second longitudinal direction 519 than are the first tabs 514. The extra space in the second tabs 516 can provide a housing, recess, or protection for a portion of the pins inserted into the pin receiving holes 518, such as protection for the pin heads.

In some embodiments, the socket connector 502 can be configured to receive a double rope socket, instead of a single rope socket.

As seen in FIGS. 5-6, the interchangeable link 500 can comprise a monolithic body (formed from a single cast), with no detachable, moveable, or removable parts or components. Such an interchangeable link can be formed, such as by cast molding and/or machining. Appropriate materials are well known in the art, and include stainless steel, other steel alloys, iron alloys, manganese steels, high strength martensitic steels, chromium molybdenum steels, high chromium alloy irons, heat resistant stainless steels and carbon steels. Portions of some embodiments of an interchangeable link can also be hard faced (e.g., can include an overlay), such as with a manganese overlay on portions of the link subject to the greatest wear. Specific embodiments include an interchangeable link comprising high strength steel with manganese bushings and a chrome carbide overlay. One specific embodiment of an interchangeable link comprises high strength steel with manganese bushings and a tungsten carbide overlay.

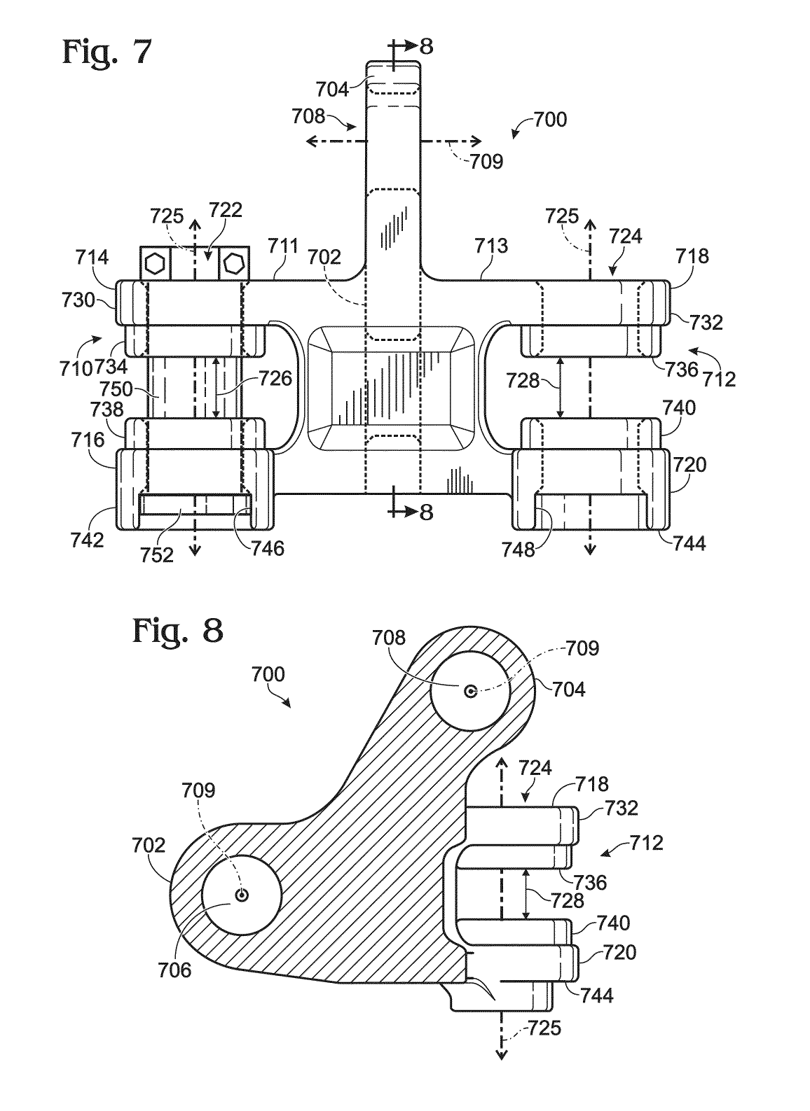

FIG. 7 shows an elevation view of one embodiment of an interchangeable dragline rigging link 700, and FIG. 8 shows a section view of the link 700 taken along line 8-8 of FIG. 7. The interchangeable link 700 can include a socket connector 702 and a dump connector 704, each having a pin receiving hole 706, 708, respectively, extending there through. Pin receiving holes 706, 708 can extend in a first longitudinal direction indicted by arrow 709, substantially parallel to one another.

Interchangeable link 700 can also include chain connectors 710, 712 on opposing sides 711, 713 of the link. Chain connector 710 can comprise an upper tab 714 and a lower tab 716 spaced apart from one another by a gap 726. Similarly, chain connector 712 can comprise an upper tab 718 and a lower tab 720 spaced apart from one another by a gap 728.

Each chain connector 710, 712 can be configured to receive a pin, such as through a pin receiving hole 722, 724, respectively. Pin receiving hole 722 extends through the upper tab 714 and lower tab 716 of the chain connector 710. Similarly, pin receiving hole 724 extends through the upper tab 718 and lower tab 720 of the chain connector 712. Pin receiving holes 722, 724 can be substantially parallel to one another, and can extend in a second longitudinal direction indicated by arrow 725, where the second longitudinal direction 725 is substantially perpendicular to the first longitudinal direction 709 of the pin receiving holes 706, 708.

Gaps 726, 728 can be large enough to accommodate a link, such as an end link of a chain. Thus a chain can be coupled to each of the chain connectors 710, 712 by a pin inserted through a chain link and the pin receiving hole 722, 724, respectively. The gaps 726, 728 can allow for rotation of a chain about a pin inserted into the pin receiving hole 722, 724, respectively. For example, chains coupled to the chain connectors 710 and 712 can be allowed to swing side to side along the first longitudinal direction (parallel to the pin receiving holes 706, 708 of the socket connector 702 and dump connector 704).

Each upper tab 714, 718 of the chain connectors 710, 712 can comprise an upper portion 730, 732 having a greater outer diameter than a lower portion 734, 736. Each lower tab 716, 720 of the chain connectors 710, 712 can comprise an upper portion 738, 740 having a smaller outer diameter than a lower pin protector extension portion 742, 744, respectively. The pin protector extension portions 742, 744 can include a cutout, or recess, 746, 748, that can allow access to the pin head or pin retainer of a pin inserted into the pin receiving holes 722, 724, while the pin protector extension portions 742, 744 of the lower tabs 716, 720 can at least partially cover the pin head or pin retainer, thus protecting it while the link 700 is dragged across the ground.

For example, FIG. 7 shows a pin 750 inserted into pin receiving hole 722 for illustration purposes. A pin head 752 of the pin 750 is at least partially covered by the pin extension portion 742 of the lower tab 716 of the chain connector 710. The pin extension portion 742 can protect the pin head 752 from damage, while the recess 746 can provide access to the pin head 752. In alternative embodiments, pin 750 can be oriented such that the pin retainer of the pin 750, rather than the pin head 752, is at least partially protected by the pin extension portion 742.

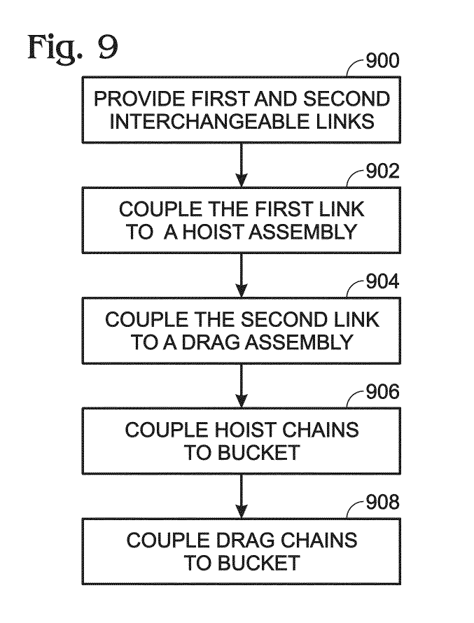

FIG. 9 is a block diagram illustrating one method of assembling a dragline rigging. In the method illustrated in FIG. 9, first and second dragline rigging links can be provided (step 900). The first and second dragline rigging links can be interchangeable, such as by being useful in more than one location within a dragline rigging assembly. As described above, interchangeable dragline rigging links can be used in one orientation as a hoist link at the hoist assembly above the bucket, and used in a second orientation as a drag link at the drag assembly. Thus, the first dragline rigging link can be coupled to a hoist socket, one or more hoist chain assemblies, and a dump assembly via a plurality of pins (step 902) and the second dragline rigging link can be coupled to a drag socket, one or more drag chain assemblies, and a dump assembly (e.g., via a dump rope) via a plurality of pins (step 904).

The one or more hoist chain assemblies can be coupled to opposing sides of a bucket (step 906), and the one or more drag chain assemblies can be coupled to the bucket, adjacent a bucket opening (step 908). The hoist chain assemblies can each comprise an upper hoist chain and a lower hoist chain, wherein the upper and lower hoist chains are coupled via a spreader bar assembly (see FIG. 2), the upper hoist chains being coupled to the first dragline rigging link, and the lower hoist chains being connected to the bucket, such as, for example, by a trunnion on either side of the bucket or by one continuous strand coupled to a trunnion mounted inside the bucket.

In some methods, each of the plurality of pins used to couple components together can be the same size. In this way, the inventory of parts required for repair and maintenance of a dragline rigging can be reduced, thus simplifying such maintenance operations.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A dragline rigging link that can be positioned interchangeably as a drag link or a hoist link in a dragline bucket rigging, the link comprising:
a socket connector adjacent an upper end of the dragline rigging link and having a first pin receiving hole extending there through in a first longitudinal direction;
a dump connector adjacent a lower end of the dragline rigging link and having a second pin receiving hole extending there through in the first longitudinal direction; and
first and second chain connectors positioned along opposing sides of the dragline rigging link, each of the first and second chain connectors being configured to receive a pin in a second longitudinal direction, wherein the second longitudinal direction is substantially perpendicular to the first longitudinal direction.

2. The dragline rigging link according to claim 1, wherein the first and second chain connectors are configured to allow movement of chains in the first longitudinal direction, when said chains are coupled to the first and second chain connectors.

3. The dragline rigging link according to claim 1, wherein the first and second chain connectors are configured to allow rotation of chains about an axis in the second longitudinal direction when said chains are coupled to the first and second chain connectors.

4. The dragline rigging link according to claim 1, wherein a socket is coupled to the socket connector, and the socket and socket connector are configured to allow movement of chains in the second longitudinal direction when said chains are coupled to the first and second chain connectors.

5. The dragline rigging link according to claim 1, wherein the first and second chain connectors each has a pin protector extension that protects pins mounted in the chain connectors when the link is dragged.

6. The dragline rigging link according to claim 1, wherein each of the first and second chain connectors comprises a first and second chain connector tab spaced apart from one another for receiving a chain link between the tabs.

7. The dragline rigging link according to claim 6, wherein each of the second chain connector tabs comprises a recess configured to accommodate a pin head.

8. The draggling rigging link of claim 6, wherein at least a portion of each of the second chain connector tabs is hard faced.

9. The dragline rigging link according to claim 1, wherein the dump connector comprises a single tab or double tabs.

10. The dragline rigging link according to claim 1, wherein the socket connector comprises a single tab or double tabs.

11. The dragline rigging link according to claim 1, wherein the dragline rigging link is monolithic.

12. The dragline rigging link according to claim 1, wherein the first and second chain connectors are configured to receive pins of the same size that the pin receiving holes of the dump connector and socket connector are configured to receive.

13. The dragline rigging link according to claim 1, wherein the socket connector is sized to receive a same socket whether the link is positioned as a hoist or drag link.

14. A dragline rigging assembly, comprising:
a hoist link assembly comprising a hoist socket coupled to a socket connector of a first dragline rigging link, a dump assembly coupled to a dump connector of the first dragline rigging link, first and second hoist chains coupled to first and second chain connectors of the first dragline rigging link, said first and second hoist chains being coupled to opposing sides of a bucket; and
a drag link assembly comprising a drag socket coupled to a socket connector of a second dragline rigging link, a dump assembly coupled to a dump connector of the second dragline rigging link, first and second drag chains coupled to first and second chain connectors of the second dragline rigging link, said first and second drag chains being coupled to the bucket, adjacent a bucket opening, wherein said first and second dragline rigging links are interchangeable.

15. The dragline rigging assembly of claim 14, wherein the hoist link assembly is configured to allow both forward and back motion and side to side motion of the first and second hoist chains.

16. The dragline rigging assembly of claim 14, wherein the drag link assembly is configured to allow both up and down motion and side to side motion of the first and second drag chains.

17. The dragline rigging assembly of claim 14, wherein the socket connector and the dump connector of the first and second dragline rigging links each includes a pin receiving hole configured to receive a pin oriented in a first direction, and wherein the first and second chain connectors of the first and second dragline rigging links are each configured to receive a pin oriented in a second direction substantially perpendicular to the first direction.

18. The dragline rigging assembly of claim 17, wherein each pin receiving hole is configured to receive the same size pin as each of the first and second chain connectors.

19. A method of assembling a dragline rigging assembly, comprising:
providing first and second dragline rigging links, wherein the first and second dragline rigging links are interchangeable;
coupling the first dragline rigging link to a hoist socket, one or more hoist chain assemblies, and a dump block via a plurality of pins;
coupling the second dragline rigging link to a drag socket, one or more drag chain assemblies, and a dump rope via a plurality of pins;
coupling the one or more hoist chain assemblies to opposing sides of a bucket; and
coupling the one or more drag chain assemblies to the bucket, adjacent a bucket opening.

20. The method according to claim 19, wherein each of the plurality of pins is the same size and the hoist socket is identical to the drag socket.

21. The method according to claim 19, wherein the hoist chain assemblies each comprises an upper hoist chain and a lower hoist chain, wherein the upper and lower hoist chains are coupled via a spreader bar assembly, the upper hoist chains being coupled to the first dragline rigging link, and the lower hoist chains being connected to the bucket via a trunnion.
